(19) United States
(12) Patent Application Publication
(10) Pub. No.: US 2024/0167820 A1
(43) Pub. Date: May 23, 2024

(54) Method of Recognizing Parking Floor for Vehicle and Recording Medium Storing Program to Execute the Method

(71) Applicants: Hyundai Motor Company, Seoul (KR); Kia Corporation, Seoul (KR)

(72) Inventors: Tae Young Heo, Yongin-si (KR); Nam Chung Paik, Goyang-si (KR); Kyu Nam Choi, Incheon (KR); Ja Ho Koo, Seoul (KR); Jung Eun Lee, Yongin-si (KR); Seung Eun Kim, Seoul (KR); Seung Woo Ha, Seoul (KR)

(21) Appl. No.: 18/329,837

(22) Filed: Jun. 6, 2023

(30) Foreign Application Priority Data
Nov. 23, 2022 (KR) 10-2022-0158049

(51) Int. Cl. G01C 21/00; G01C 9/02; G01C 21/16

(52) U.S. Cl. CPC G01C 21/005; G01C 9/02; G01C 21/165

(57) ABSTRACT

An embodiment method of recognizing a parking floor for a vehicle includes recognizing a spot at which the vehicle enters a parking deck, obtaining an inclination signal indicating an inclination trajectory of the vehicle traveling during a parking period from entry to the parking deck to parking, obtaining an inclination pulse of the inclination signal based on a reference inclination value, and determining a floor number of the parking deck on which the vehicle is parked using the inclination pulse.

### CROSS-REFERENCE TO RELATED APPLICATIONS

This application claims the benefit of Korean Patent Application No. 10-2022-0158049, filed on Nov. 23, 2022, which application is hereby incorporated herein by reference.

### TECHNICAL FIELD

Embodiments relate to a method of recognizing a parking floor for a vehicle and a recording medium storing a program to execute the method.

### BACKGROUND

After parking his/her vehicle in a building, a user may forget the vehicle parking location. In particular, in the case of a large multi-story building, the size of a parking deck is not only very large, but vehicles may also be parked on a plurality of floors. As a representative example of methods of finding a vehicle parking location, there is a method of receiving, by a user terminal, a global positioning system (GPS) signal. However, this method has a problem in that the intensity of the GPS signal is weak or the GPS signal is not received when a vehicle is parked underground or indoors.

In particular, it is more difficult for a user to find his/her parked vehicle when forgetting the floor he/she parked on than when remembering the parking floor but forgetting the parking location on the corresponding parking floor. Therefore, research with the goal of solving this problem is underway.

Korean Patent Laid-Open Publication No. 10-2018-0012128 and Korean Patent Laid-Open Publication No. 10-2020-0046868 disclose subject matter similar to subject matter disclosed herein.

### SUMMARY

Accordingly, embodiments are directed to a method of recognizing a parking floor for a vehicle and a recording medium storing a program to execute the method that substantially obviate one or more problems due to limitations and disadvantages of the related art.

Embodiments provide a parking floor recognition method capable of accurately estimating and recognizing a floor on which a vehicle is parked and a recording medium storing a program to execute the method.

However, features that may be accomplished by the embodiments are not limited to the above-mentioned features, and other features not mentioned herein will be clearly understood by those skilled in the art from the following description.

A method of recognizing a parking floor for a vehicle according to an embodiment may include recognizing a spot at which the vehicle enters a parking deck, obtaining an inclination signal indicating an inclination trajectory of the vehicle traveling during a parking period from entry to the parking deck to parking, obtaining an inclination pulse of the inclination signal based on a reference inclination value, and determining a floor number of the parking deck in which the vehicle is parked using the inclination pulse.

In an example, polygon information about a building having the parking deck and about an entrance of the parking deck may be compared with GPS information of the vehicle to recognize the building that the vehicle has entered and the entrance that the vehicle has entered.

In an example, inclination values of the vehicle calculated during the parking period may be accumulated to generate the inclination signal.

In an example, the obtaining an inclination pulse may include setting the reference inclination value and determining a section of the inclination signal, not including the set reference inclination value, to be the inclination pulse.

In an example, an inclination value of 0 may be set as the reference inclination value.

In an example, an inclination value most frequently intersecting the inclination signal may be set as the reference inclination value.

In an example, the reference inclination value may be greater than 0 by a predetermined value.

In an example, adjacent sections of the inclination signal may be regarded as either one inclination pulse or separate inclination pulses.

In an example, the method may further include notifying a user of the determined floor number.

In an example, the method may further include, upon receiving a request for correction of the determined floor number, re-determining the floor number in a manner of regarding the adjacent sections as the other of separate inclination pulses and one inclination pulse.

In an example, the determining a floor number may include assigning +1 to an inclination pulse corresponding to a section having an inclination value greater than the reference inclination value and assigning −1 to an inclination pulse corresponding to a section having an inclination value smaller than the reference inclination value, summing all of values assigned to inclination pulses, and adding 1 to a result of the summing.

In an example, a result of the adding may be determined to be a final floor number.

In an example, the determining a floor number may further include obtaining an acceleration signal indicating a trajectory of an acceleration of the vehicle during the parking period, obtaining an acceleration pulse of the acceleration signal, determining a floor number using the acceleration pulse, and determining a larger value among the floor number obtained using the inclination pulse and the floor number obtained using the acceleration pulse to be a final floor number.

In an example, the determining a floor number may further include obtaining an acceleration signal indicating a trajectory of an acceleration of the vehicle during the parking period, obtaining an acceleration pulse of the acceleration signal, determining a floor number using the acceleration pulse, obtaining a steering angle signal indicating a trajectory of a steering angle of the vehicle during the parking period, obtaining a steering angle pulse of the steering angle signal, determining a floor number using the steering angle pulse, and determining a median value among floor numbers obtained using the inclination pulse, the acceleration pulse, and the steering angle pulse to be a final floor number.

According to another embodiment, a recording medium having therein a program to execute a method of recognizing a parking floor for a vehicle may store a program to implement a function of recognizing a spot at which the vehicle enters a parking deck, a function of obtaining an inclination signal indicating an inclination trajectory of the vehicle traveling during a parking period from entry to the parking deck to parking, a function of obtaining an inclination pulse of the inclination signal based on a reference inclination value, and a function of determining a floor number of the parking deck in which the vehicle is parked using the inclination pulse.

### BRIEF DESCRIPTION OF THE DRAWINGS

The accompanying drawings, which are included to provide a further understanding of embodiments of the disclosure and are incorporated in and constitute a part of this application, illustrate exemplary embodiments of the disclosure and together with the description serve to explain the principle of embodiments of the disclosure. In the drawings:

FIG. 1 is a flowchart for explaining a method of recognizing a parking floor for a vehicle according to an embodiment;

FIG. 2 is a plan view illustrating a building polygon;

FIG. 3 is a graph showing a change in steering angle after entering a polygon setting zone;

FIG. 4 is a waveform diagram illustrating an inclination signal;

FIG. 5 is a flowchart for explaining an embodiment of step 150 shown in FIG. 1;

FIG. 6 is a flowchart for explaining another embodiment of step 150 shown in FIG. 1;

FIGS. 7A and 7B are diagrams for aiding in understanding of the embodiment shown in FIG. 6;

FIG. 8 is a flowchart for explaining still another embodiment of step 150 shown in FIG. 1;

FIGS. 9A to 9C are diagrams for aiding in understanding of the embodiment shown in FIG. 8; and

FIG. 10 is a diagram illustrating a sign indicating a floor number of a parking deck in which a vehicle is parked.

### DETAILED DESCRIPTION OF ILLUSTRATIVE EMBODIMENTS

Embodiments of the present disclosure will now be described more fully hereinafter with reference to the accompanying drawings, in which various embodiments are shown. The examples, however, may be embodied in many different forms and should not be construed as being limited to the embodiments set forth herein. Rather, these embodiments are provided so that this disclosure will be more thorough and complete and will more fully convey the scope of embodiments of the disclosure to those skilled in the art.

It will be understood that when an element is referred to as being “on” or “under” another element, it may be directly on/under the element, or one or more intervening elements may also be present.

When an element is referred to as being “on” or “under,” “under the element” as well as “on the element” may be included based on the element.

In addition, relational terms, such as “first,” “second,” “on/upper part/above,” and “under/lower part/below” are used only to distinguish between one subject or element and another subject or element, without necessarily requiring or involving any physical or logical relationship or sequence between the subjects or elements.

Hereinafter, a method of recognizing a parking floor for a vehicle according to embodiments will be described with reference to the accompanying drawings.

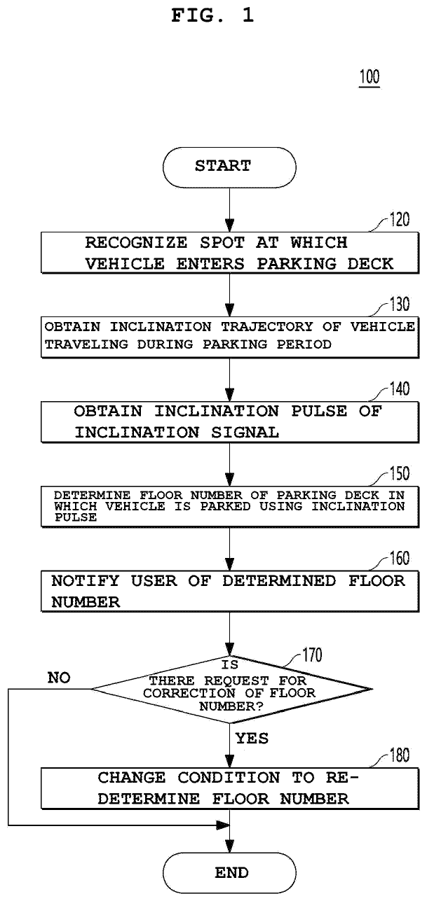

FIG. 1 is a flowchart for explaining a method 100 of recognizing a parking floor for a vehicle according to an embodiment.

According to the embodiment, a spot at which a vehicle enters a parking deck is recognized (step 120).

After step 120, an inclination signal indicating an inclination trajectory of the vehicle traveling during the time period PT from entry to the parking deck to parking (hereinafter referred to as a “parking period”) is obtained (step 130).

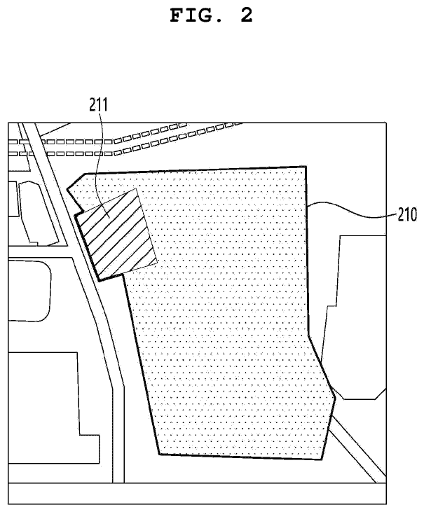

FIG. 2 is a plan view illustrating a building polygon.

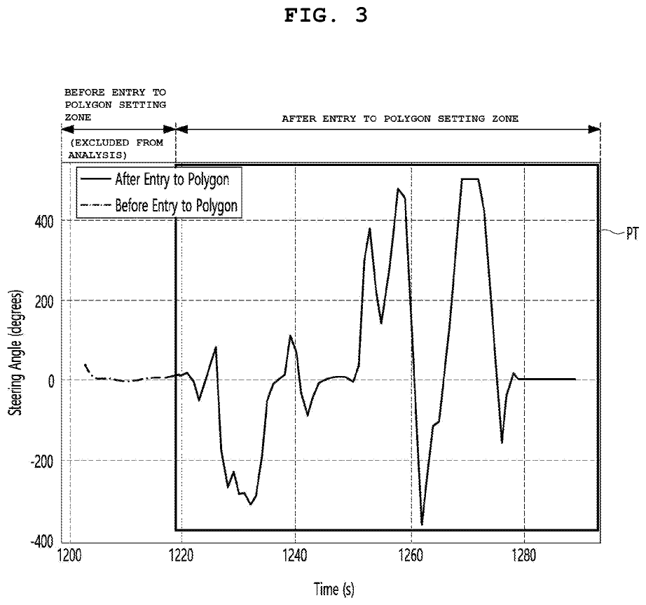

FIG. 3 is a graph showing a change in steering angle after entering a polygon setting zone. In FIG. 3, the vertical axis represents a steering angle, and the horizontal axis represents time.

In order to perform step 120, for example, as shown in FIG. 2, polygon information about a building 210 having a parking deck 211 and an entrance of the parking deck 211 of the building 210 may be compared with GPS information (or sensor data) of the vehicle to recognize the building 210 that the vehicle has entered and the entrance of the parking deck 211 that the vehicle has entered in the building 210. The GPS information may include both location information of the parking deck 211 and information about the polygon.

If there is a plurality of parking deck entrances in the building, previously acquired information about the building and the parking deck entrances in the building may be compared with GPS information of the vehicle entering the parking deck to recognize the entrance of the parking deck that the vehicle has entered.

Referring to FIG. 3, when the steering angle is analyzed, data generated before entry to the polygon setting zone (e.g., 211 in FIG. 2) is not used, and only data generated during the parking period PT from entry to the polygon setting zone to parking is used. Similarly, in the embodiment, a floor on which the vehicle is parked (or a parking floor) may be estimated and determined using an inclination signal generated during the parking period PT from entry to the polygon setting zone to parking.

According to the embodiment, the vehicle may calculate an inclination value (or an inclination angle or a slope) at which the vehicle is traveling during the parking period PT and may accumulate the calculated inclination values to generate an inclination signal (step 130). According to the embodiment, the inclination signal may be obtained using engine torque, turbine torque, and gearbox torque. However, the embodiments are not limited to any specific method of generating the inclination signal.

In an example, the inclination value may be calculated using a method of obtaining the slope θ in Equation 1 disclosed in Korean Patent Laid-Open Publication No. 10-2018-0012128 (hereinafter referred to as “first conventional art”).

In another example, the inclination angle θ in Equation 2 disclosed in Korean Patent Laid-Open Publication No. 10-2020-0046868 (hereinafter referred to as “second conventional art”) may be calculated as the inclination value.

In addition, according to an embodiment, the inclination signal may be generated by the vehicle itself. In this case, the inclination signal may be generated by the vehicle itself and may then be transmitted to a server.

Alternatively, information necessary to generate the inclination signal may be transmitted from the vehicle to a server (not shown), the server may generate the inclination signal, and the vehicle may receive the inclination signal calculated by the server.

If the vehicle is a connected car, both GPS information and an inclination signal (i.e., slope information) may be included in connected data transmitted from a server related to vehicle customer relationship management (VCRM) through CAN communication. The inclination signal transmitted from the server may be normally received by the vehicle even when the vehicle is parked underground, unlike the GPS information.

After step 130, a pulse of the inclination signal (hereinafter referred to as an “inclination pulse”) is obtained based on a reference inclination value (step 140). Here, the pulse may mean a wave having a large amplitude for a very short time and may mean a maximum peak value within a unit time.

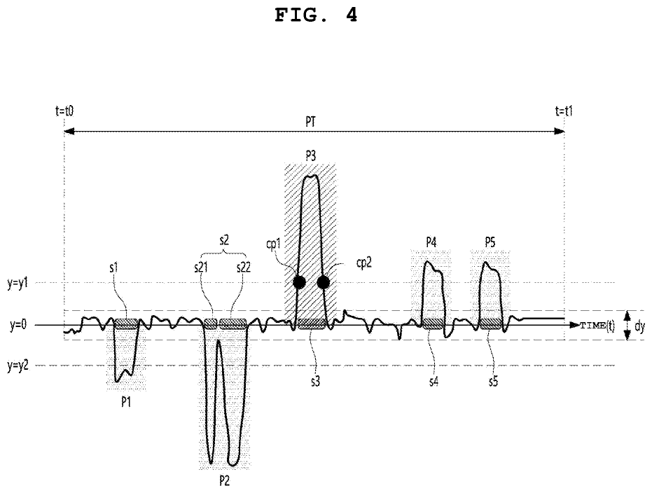

FIG. 4 is a waveform diagram illustrating an inclination signal. In FIG. 4, the vertical axis represents the inclination value, and the horizontal axis represents time.

In FIG. 4, a point at which time t is “t0” indicates a time point at which the vehicle entered the entrance of the parking deck, and a point at which time t is “t1” indicates a time point at which the vehicle was parked on the parking floor. Accordingly, the parking period PT corresponds to the period from “t0” to “t1,” as shown in FIG. 4.

In order to perform step 140, a reference inclination value may first be set.

According to one embodiment, an inclination value of 0 (y=0) shown in FIG. 4 may be set as the reference inclination value.

According to another embodiment, an inclination value other than 0 (y=y1 or y=y2) shown in FIG. 4 may be set as the reference inclination value. For example, an inclination value that most frequently intersects the inclination signal may be set as the reference inclination value. Referring to FIG. 4, when the inclination value y is “y1,” the third pulse P3 has two intersection points cp1 and cp2. An inclination value y having the most points of intersection with the inclination signal may be obtained while being moved vertically, and the obtained inclination value y may be set as the reference inclination value. When one of “y1” and “y2” is set as the reference inclination value y using the above method, an incorrect inclination pulse may be obtained due to a noise component. In order to prevent this problem, according to the embodiment, an inclination value greater than 0 by a predetermined value or greater may be set as the reference inclination value. Here, the predetermined value may be “dy/2,” as illustrated in FIG. 4. “dy” represents a section within which the level of an inclination value generated by noise, i.e., the level of an inclination value much less than pulses P1 to P5, rather than the level of the actual inclination value of the vehicle, falls.

However, when the inclination value y of 0 is set as the reference inclination value, the influence of the noise component dy may be reduced compared to when “y1” or “y2” is set as the reference inclination value.

Thereafter, an inclination pulse may be obtained using the set reference inclination value. That is, a section of the inclination signal that does not include the reference inclination value may be determined to be the inclination pulse.

For example, referring to FIG. 4, when the inclination value of 0 (y=0) is set as the reference inclination value, five sections s1 to s5 that do not include the reference inclination value of 0 may be determined to be the inclination pulses P1, P2, P3, P4, and P5.

According to the embodiment, sections of the inclination signal that are adjacent to each other may be regarded as one inclination pulse or separate inclination pulses. For example, referring to FIG. 4, each of 2-1^{st} and 2-2^{nd} sections s21 and s22 of the inclination signal that are adjacent to each other is a separate section that does not include the inclination value of 0. However, because these sections s21 and s22 are adjacent to each other, they may be regarded as one inclination pulse. Alternatively, although the sections s21 and s22 are adjacent to each other, they may be regarded as separate inclination pulses.

Meanwhile, referring back to FIG. 1, the floor number of the parking deck in which the vehicle is parked (hereinafter referred to as a “first floor number”) is determined (i.e., estimated) using the inclination pulse (step 150).

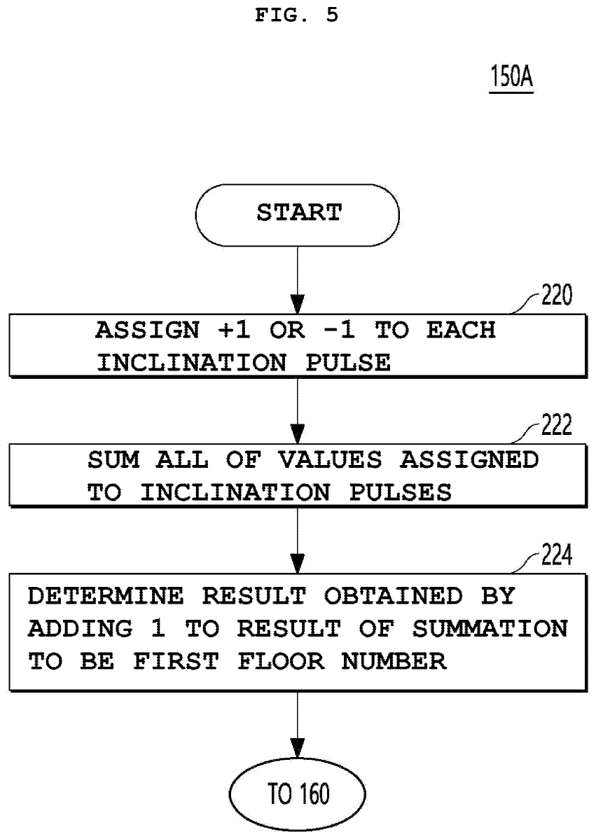

FIG. 5 is a flowchart for explaining an embodiment 150A of step 150 shown in FIG. 1.

According to one embodiment, +1 is assigned to an inclination pulse corresponding to a section having an inclination value greater than the reference inclination value, and −1 is assigned to an inclination pulse corresponding to a section having an inclination value smaller than the reference inclination value (step 220).

After step 220, all of the values assigned to the inclination pulses are summed (step 222).

After step 222, a result obtained by adding 1 to the result of summation is determined to be the first floor number (step 224).

That is, the first floor number obtained using the inclination value of the vehicle may be expressed using Equation 1 below.

fs=ps+1 Equation 1:

Here, fs represents the first floor number, and ps is as shown in Equation 2 below.

$$ps = {\sum }_{k = 1}^{K} ak \qquad Equation 2$$

Here, K represents the total number of inclination pulses, and ak represents a value assigned to the k^{th} (1≤k≤K) inclination pulse among the “K” inclination pulses. Here, ak is −1 or +1.

For example, in FIG. 4, when the inclination value of 0 is set as the reference inclination value, −1 is allocated to the first inclination pulse P1 because the first inclination pulse P1 corresponds to a section having an inclination value smaller than the reference inclination value, −1 is allocated to the second inclination pulse P2 because the second inclination pulse P2 corresponds to a section having an inclination value smaller than the reference inclination value, +1 is allocated to the third inclination pulse P3 because the third inclination pulse P3 corresponds to a section having an inclination value larger than the reference inclination value, +1 is allocated to the fourth inclination pulse P4 because the fourth inclination pulse P4 corresponds to a section having an inclination value larger than the reference inclination value, and +1 is allocated to the fifth inclination pulse P5 because the fifth inclination pulse P5 corresponds to a section having an inclination value larger than the reference inclination value (step 220). In this case, when +1 or −1 is allocated to the inclination pulse, the size (or the height) of the pulse is not considered. In this case, two sections s21 and s22 that are adjacent to each other are regarded as one inclination pulse, and −1 is allocated thereto.

Thereafter, all of the values (−1, −1, +1, +1, and +1) assigned to the inclination pulses in step 220 are summed (step 222).

Thereafter, a value obtained by adding 1 to the sum (+1) calculated in step 222, i.e., 2, is determined to be the first floor number (step 224). That is, it is determined that the vehicle is parked on the second floor. According to the embodiment, if each of second and third floor numbers to be described later as well as the first floor number has a positive (+) value, it means that the vehicle is parked in an aboveground parking deck, and if the same has a negative (−) value, it means that the vehicle is parked in an underground parking deck.

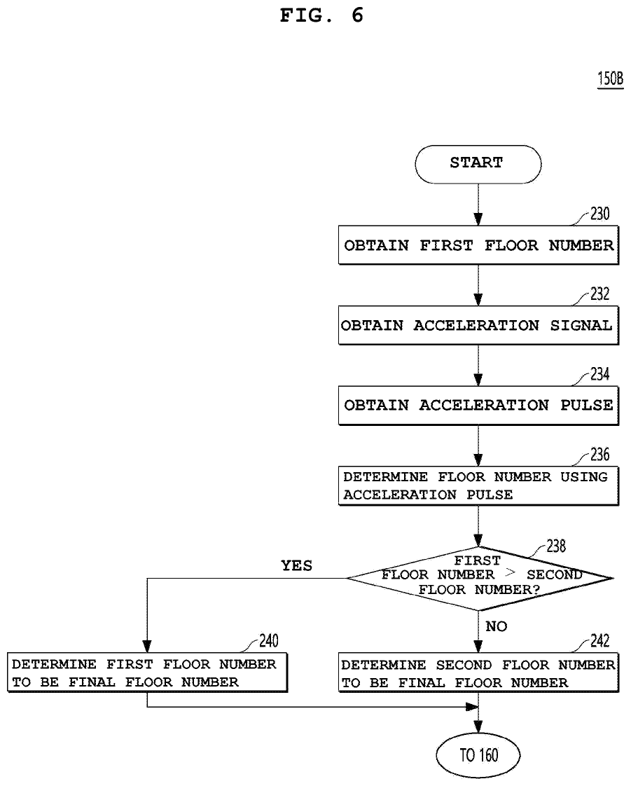

FIG. 6 is a flowchart for explaining another embodiment 150B of step 150 shown in FIG. 1.

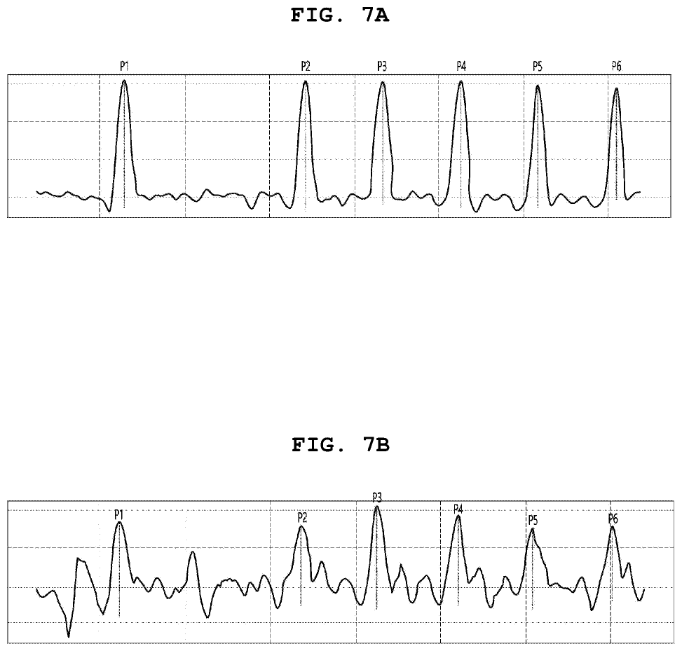

FIGS. 7A and 7B are diagrams for aiding in understanding of the embodiment shown in FIG. 6. FIG. 7A is a waveform diagram of an inclination signal, in which the horizontal axis represents time (or a cumulative distance), and the vertical axis represents an inclination value (or an inclination angle). FIG. 7B is a waveform diagram of an acceleration signal, in which the horizontal axis represents time (or a cumulative distance), and the vertical axis represents acceleration.

According to another embodiment 150B, the first floor number is obtained using the inclination signal (step 230). Since step 230 is performed as shown in FIG. 5, a duplicate description thereof will be omitted. For example, when the inclination signal is as shown in FIG. 7A, six inclination pulses P1 to P6 are obtained using the above-described method. Since all of the six inclination pulses have inclination values larger than the reference inclination value, +1 is assigned to all of the inclination pulses. In this case, “+7” is calculated as the first floor number using Equations 1 and 2 above.

After step 230, an acceleration signal indicating the trajectory of the acceleration of the vehicle (e.g., the longitudinal acceleration) is obtained during the parking period PT (step 232). The longitudinal acceleration may be sensed by the vehicle.

After step 232, a pulse having an acceleration signal (hereinafter referred to as an “acceleration pulse”) is obtained (step 234). A method of obtaining an acceleration pulse from an acceleration signal is the same as a method of obtaining an inclination pulse from an inclination signal. That is, after a reference acceleration is set, an acceleration pulse may be obtained using the reference acceleration. In this case, an acceleration of 0 may be set as the reference acceleration, or an acceleration that most frequently intersects the acceleration signal may be set as the reference acceleration. In addition, a section that does not include the reference acceleration may be obtained as the acceleration pulse. For example, when the acceleration signal is as shown in FIG. 7B, six acceleration pulses P1 to P6 may be obtained.

After step 234, a floor number (hereinafter referred to as a “second floor number”) is determined using the acceleration pulse (step 236). The second floor number may be obtained through the same method as the method of obtaining the first floor number using the inclination pulse.

That is, the second floor number of the parking deck in which the vehicle is parked, which is obtained using the acceleration of the vehicle, may be expressed using Equation 3 below.

fl=pl+1 Equation 3:

Here, fl represents the second floor number, and pl is as shown in Equation 4 below.

$$pl = {\sum }_{l = 1}^{L} al \qquad Equation 4$$

Here, L represents the total number of acceleration pulses, and al represents a value assigned to the l^{th} (1≤1≤L) acceleration pulse among the “L” acceleration pulses. Here, al is −1 or +1.

Accordingly, when the acceleration pulse is obtained as shown in FIG. 7B, the second floor number is determined to be “+7.”

Alternatively, unlike what is shown in FIG. 6, step 230 may be performed after step 236 or may be performed simultaneously with steps 232 to 236.

After step 236, a larger value among the first floor number and the second floor number is determined to be a final floor number (steps 238 to 242). That is, a determination is made as to whether the first floor number is equal to or greater than the second floor number (step 238). If the first floor number is equal to or greater than the second floor number, the first floor number is determined to be the final floor number (step 240). If the second floor number is greater than the first floor number, the second floor number is determined to be the final floor number (step 242). In the case shown in FIGS. 7A and 7B, since both the first floor number and the second floor number are +7, the floor on which the vehicle is parked is finally determined to be the 7^{th} floor.

That is, the final floor number (F: Floor) may be determined as shown in Equation 5 below.

F=Max(fs,fl) Equation 5:

Here, Max(A, B) represents a larger value among A and B.

Alternatively, unlike what is shown in Equation 5, only when the first floor number and the second floor number are equal to each other, the first or second floor number may be determined to be the final floor number.

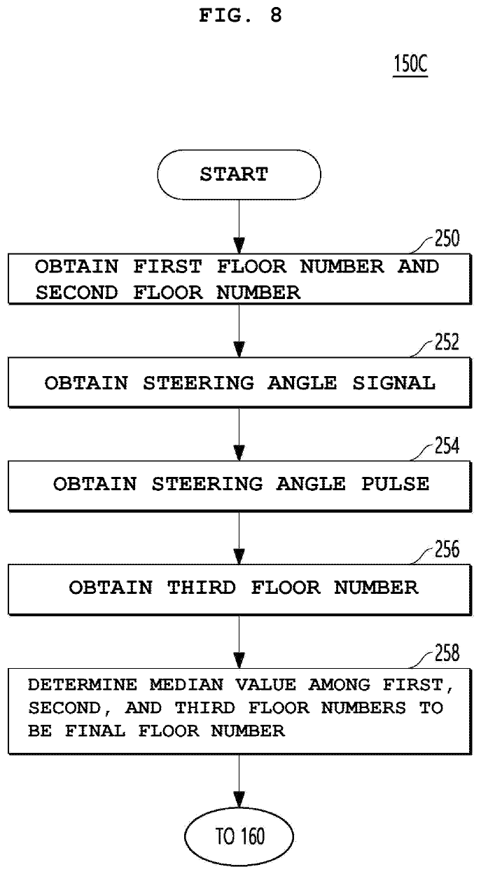

FIG. 8 is a flowchart for explaining still another embodiment 150C of step 150 shown in FIG. 1.

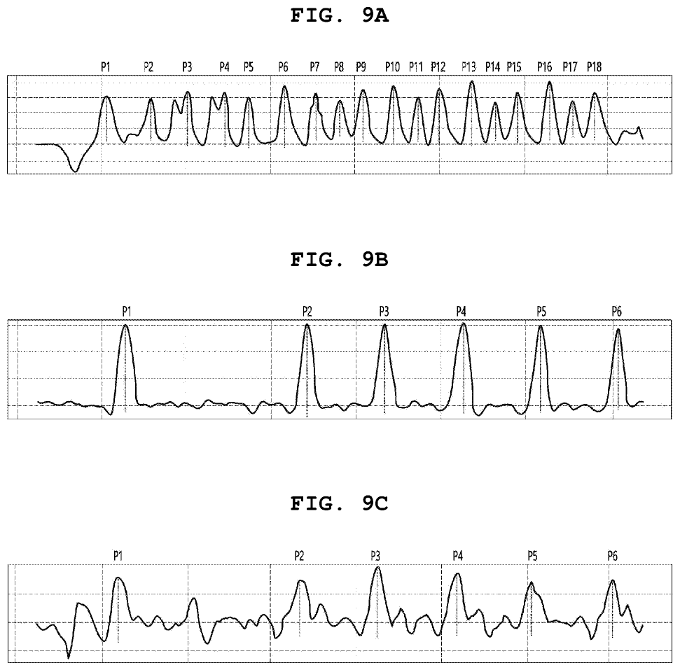

FIGS. 9A to 9C are diagrams for aiding in understanding of the embodiment shown in FIG. 8. FIG. 9A is a waveform diagram of a steering angle signal, in which the horizontal axis represents time (or a cumulative distance), and the vertical axis represents a steering angle. FIG. 9B is a waveform diagram of an inclination signal, in which the horizontal axis represents time (or a cumulative distance), and the vertical axis represents an inclination value. FIG. 9C is a waveform diagram of an acceleration signal, in which the horizontal axis represents time (or a cumulative distance), and the vertical axis represents acceleration.

According to still another embodiment, the first floor number is obtained using an inclination signal, and the second floor number is obtained using an acceleration signal (step 250). In step 250, the first floor number may be obtained as shown in FIG. 5, and the second floor number may be obtained as shown in FIG. 6. Therefore, a duplicate description thereof will be omitted.

For example, when the inclination signal is as shown in FIG. 9B, six inclination pulses P1 to P6 are obtained through the above-described method. Since all of the six inclination pulses are greater than the reference inclination value, +1 is assigned to all of the inclination pulses. In this case, “+7” is calculated as the first floor number using Equations 1 and 2 above.

In addition, when the acceleration signal is as shown in FIG. 9C, six acceleration pulses P1 to P6 are obtained through the above-described method. Since all of the six acceleration pulses are greater than the reference acceleration value, +1 is assigned to all of the acceleration pulses. In this case, “+7” is calculated as the second floor number using Equations 1 and 2 above.

After step 250, a steering angle signal indicating the trajectory of the steering angle of the vehicle is obtained during the parking period PT (step 252). The steering angle may be sensed by the vehicle.

After step 252, a pulse having a steering angle signal (hereinafter referred to as a “steering angle pulse”) is obtained (step 254). A method of obtaining a steering angle pulse from a steering angle signal is the same as a method of obtaining an inclination pulse from an inclination signal. That is, after a reference steering angle is set, a steering angle pulse may be obtained using the reference steering angle. In this case, a steering angle of 0 may be set as the reference steering angle, or a steering angle that most frequently intersects the steering angle signal may be set as the reference steering angle. In addition, a section that does not include the reference steering angle may be determined to be the steering angle pulse. For example, when the steering angle signal is obtained as shown in FIG. 9A, eighteen steering angle pulses P1 to P18 may be obtained.

After step 254, a floor number (hereinafter referred to as a “third floor number”) is determined using the steering angle pulse (step 256). The third floor number of the parking deck in which the vehicle is parked may be obtained using the steering angle of the vehicle, as shown in Equation 6 below.

$$fa = floor ( \frac{pa - 1}{3} ) + 2 \qquad Equation 6$$

Here, fa represents the third floor number, floor(x) represents an integer number obtained by removing numbers below the decimal point from “x” (e.g., floor(2.6)=2), and pa is as shown in Equation 7 below.

$$pa = {\sum }_{m = 1}^{M} am \qquad Equation 7$$

Here, M represents the total number of steering angle pulses, and am represents a value assigned to the m^{th} (1≤m≤M) steering angle pulse among the “M” steering angle pulses. Here, am is −1 or +1.

For example, when the steering angle pulse is obtained as shown in FIG. 9A, the third floor number may be determined to be “+7.”

Alternatively, unlike what is shown in FIG. 8, step 250 may be performed after step 256 or may be performed simultaneously with steps 252 to 256.

After step 256, a median value among the first floor number, the second floor number, and the third floor number is determined to be the final floor number (step 258). For example, when the second floor number is a median value among the first to third floor numbers, the second floor number is determined to be the final floor number. That is, the final floor number F may be determined as shown in Equation 8 below.

F=Median(fa,fs,fl) Equation 8:

Here, Median(A, B, C) represents a median value among A, B, and C.

Alternatively, unlike what is shown in Equation 8, only when the first to third floor numbers are equal to each other, the first, second, or third floor number may be determined to be the final floor number.

Meanwhile, referring back to FIG. 1, after step 150, a user may be notified of the determined floor number (step 160). For example, such a notification may be given to a user (e.g., a passenger or a driver of the vehicle) in the form of at least one of a visual signal or an audio signal.

In this case, when the determined floor number is incorrect, the user may request correction of the determined floor number. Therefore, the vehicle determines whether there is a request for correction of the floor number (step 170).

When there is a request for correction of the floor number, at least one of the conditions used to determine the floor number of the floor on which the vehicle is parked may be changed to again determine the floor number of the floor on which the vehicle is parked (step 180).

For example, when a request for correction is received from the user after the floor number is determined in a manner in which the two adjacent sections s21 and S22 shown in FIG. 4 are regarded as one inclination pulse, the floor number may be determined again in a manner in which the two adjacent sections s21 and s22 are regarded as separate inclination pulses. Alternatively, when a request for correction is received from the user after the floor number is determined in a manner in which the two adjacent sections s21 and S22 shown in FIG. 4 are regarded as separate inclination pulses, the floor number may be determined again in a manner in which the two adjacent sections s21 and s22 are regarded as one inclination pulse.

The parking floor recognition method according to the above-described embodiment may be performed by the vehicle itself. Alternatively, some processes of the parking floor recognition method may be performed by the vehicle itself, and the remaining processes thereof may be performed by a server, rather than the vehicle, and results of performance may be provided to the vehicle. In particular, at least one of step 140, step 150, or step 180 described above may be performed by a server, and a result of performance may be provided to the vehicle. Alternatively, at least one of step 140, step 150, or step 180 may be performed by the vehicle.

In order to exchange data with the server, the vehicle performing the parking floor recognition method according to the embodiment may be a connected car. However, the embodiments are not limited to any specific type of vehicle.

Hereinafter, a recording medium storing a program to execute the method of recognizing a parking floor for a vehicle according to an embodiment will be described.

A program recorded in a computer-readable recording medium may implement a function of recognizing a spot at which the vehicle enters a parking deck, a function of obtaining an inclination signal indicating an inclination trajectory of the vehicle traveling during the parking period from entry to the parking deck to parking, a function of obtaining an inclination pulse of the inclination signal based on a reference inclination value, and a function of determining a floor number of the parking deck in which the vehicle is parked using the inclination pulse.

The computer-readable recording medium includes all kinds of storage devices in which data that may be read by a computer system is stored. Examples of the computer-readable recording medium may include ROM, RAM, a CD-ROM, a magnetic tape, a floppy disk, and an optical data storage device. The computer-readable recording medium may also be distributed over network-coupled computer systems so that the computer-readable code is stored and executed in a distributed fashion. Also, functional programs, code, and code segments for accomplishing the method of recognizing a parking floor for a vehicle may be easily construed by programmers skilled in the art to which the present disclosure pertains.

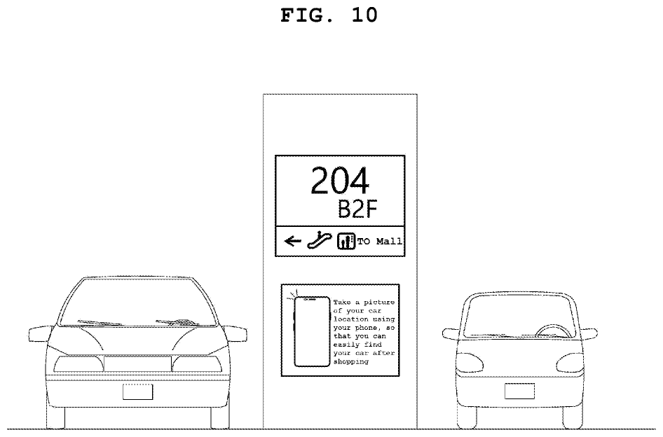

FIG. 10 is a diagram illustrating a sign indicating the floor number of the parking deck in which the vehicle is parked.

In general, when parking his/her vehicle in a parking deck, a user takes a picture of a sign indicating information about the place at which his/her vehicle is parked as shown in FIG. 10 in order to easily find the vehicle parking location later. In this case, the floor number of the place at which the vehicle is parked is particularly important. The reason for this is that it is more difficult for a user to find his/her parked vehicle when forgetting the floor he/she parked on than when remembering the parking floor but forgetting the parking location on the corresponding parking floor.

In the case of a parking deck in a large multi-story building such as a department store, a customer is encouraged to take a picture of a sign indicating his/her vehicle parking location as shown in FIG. 10 so that the customer can easily find his/her parked vehicle. However, it is inconvenient to take a picture whenever parking.

In order to obviate such inconvenience, some parking decks are equipped with a location notification system including sensors or cameras, thereby providing information about a customer's vehicle parking location to the customer when desired. However, because it is costly to build a location notification system, only a limited number of large-scale parking decks are equipped with a location notification system.

In contrast, according to the embodiments, the vehicle may autonomously estimate and recognize the floor number of the parking deck in which the vehicle is parked and may provide the recognized floor number to a user. Accordingly, it is possible to obviate the inconvenience of taking a picture of a sign indicating a vehicle parking location (refer to FIG. 10), and it is not necessary to use an external location notification system or to mount separate equipment in the vehicle.

In addition, according to the embodiments, even if the form of the inclination signal varies depending on the structure of a parking deck, an optimization process reflecting the characteristics of the inclination signal is not required for each parking deck, and the need for tailoring of the inclination signal for each parking deck is minimized. For example, even if the floor height and the inclination vary on a given floor of a parking deck, inclination pulses are not recognized as separate inclination pulses but are recognized as one inclination pulse. Further, even if the level of the pulse is low, it is possible to clearly recognize the pulse having a low level as an inclination pulse by appropriately setting a reference inclination value. Accordingly, the embodiments may be widely applied to various parking environments. As a result, fields to which the embodiments are to be applied are expanded, and it is possible to ensure versatility.

In addition, in the case of each of the above-mentioned first and second conventional arts, a parking floor number may be determined only when information about each floor of a parking deck is obtained in advance. In contrast, according to the embodiments, it is possible to accurately recognize a parking floor number without information about each floor of a parking deck. Accordingly, the range of applications is very wide.

In addition, according to the embodiments, since the inclination value of 0 is set as the reference inclination value, the influence of noise is eliminated, and the sensitivity of detecting an inclination pulse is very high. Therefore, even if change in the trajectory of the inclination value is minute due to a low height difference between floors of a parking deck, it is possible to accurately detect the inclination pulse, thereby accurately determining a parking floor. In particular, when there is a request for correction of the floor number, at least one of the conditions associated with two adjacent sections may be changed to again determine the floor number of the floor on which the vehicle is parked, thereby accurately determining the parking floor.

In addition, in the case of the comparative example, only when the amplitude of a pulse in an inclination signal is large, the pulse is recognized as an inclination pulse. In this case, the second and third pulses P2 and P3 having large amplitudes (refer to FIG. 4) may be determined to be inclination pulses, but the first, fourth, and fifth pulses P1, P4, and P5 having small amplitudes (refer to FIG. 4) may not be determined to be inclination pulses. For this reason, as shown in Table 1 to be described later, determined floor numbers may be inaccurate. In contrast, according to the embodiments, since the inclination pulse is set depending on whether or not a pulse includes the reference inclination value regardless of the amplitude of the pulse, the first, fourth, and fifth pulses P1, P4, and P5 having relatively small amplitudes (refer to FIG. 4) may also be determined to be inclination pulses. Accordingly, as shown in Tables 1 and 2 to be described later, floor numbers may be accurately determined.

Table 1 below shows results of determining floor numbers using methods according to the comparative example and the embodiments described above when vehicles are parked in first to third parking decks in different buildings and parked in a fourth aboveground parking deck and a fourth underground parking deck in a given building.

TABLE 1

| | | Comparative Example | | First Embodiment | | |
|---|---|---|---|---|---|---|
| | Total | Correct | Accuracy | Correct | | Accuracy |
| Target Parking Deck | Cases | Cases | (%) | Cases | | (%) |
| First Parking Deck | 691 | 537 | 77.7 | 676 | (+139) | 97.8 (+20) |
| Second Parking Deck | 1019 | 873 | 85.7 | 965 | (+92) | 94.7 (+9) |
| Third Parking Deck | 1371 | 1193 | 87.0 | 1299 | (+106) | 94.7 (+8) |
| Fourth Parking Deck | 303 | 64 | 20.9 | 255 | (+191) | 84.2 (+63) |
| (Underground) | | | | | | |
| Fourth Parking Deck | 91 | 64 | 72.7 | 86 | (+22) | 94.5 (+22) |
| (Aboveground) | | | | | | |

In Table 1, “First Embodiment” indicates results obtained by performing steps 120 to 150 shown in FIG. 1.

When the accuracy among the results shown in Table 1 above is not high or when a user requests re-determination, the floor numbers may be determined again according to a second embodiment, in which step 180 is performed while changing the condition as described above. As a result, it can be seen from Table 2 below that the accuracy increases.

TABLE 2

Second Embodiment

| | Total | Correct | Accuracy |
|---|---|---|---|
| Target Parking Deck | Cases | Cases | (%) |
| First Parking Deck | 684 | 677 | 98.9 |
| Second Parking Deck | 1004 | 949 | 94.5 |
| Third Parking Deck | 1302 | 1279 | 98.2 |
| Fourth Parking Deck | 299 | 279 | 93.3 |
| (Underground) | | | |
| Fourth Parking Deck | 82 | 80 | 97.5 |
| (Aboveground) | | | |

The embodiments may reflect another variable, namely a steering angle, when estimating a floor number. Accordingly, in the case in which a user parks his/her vehicle after turning multiple times on a given floor, a problem of overestimating a floor number may be obviated.

In addition, according to the embodiments, it is possible to accurately estimate a floor number only using an inclination angle or using an inclination angle and an acceleration without using a steering angle.

As is apparent from the above description, according to the method of recognizing a parking floor for a vehicle and the recording medium storing a program to execute the method according to the embodiments, it is possible to obviate inconvenience of taking a picture of a sign indicating a vehicle parking location, and it is not necessary to use an external location notification system or to mount separate equipment in a vehicle. Accordingly, the embodiments may be widely applied to various parking environments. As a result, fields to which the embodiments are to be applied are expanded, and it is possible to ensure versatility. In addition, it is possible to accurately recognize a parking floor number without information about each floor of a parking deck. In addition, since the influence of noise is eliminated and the sensitivity of detecting an inclination pulse is very high, it is possible to accurately determine a parking floor and to obviate a problem of overestimating a floor number.

However, the effects achievable through embodiments of the disclosure are not limited to the above-mentioned effects, and other effects not mentioned herein will be clearly understood by those skilled in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While embodiments of the present disclosure have been particularly shown and described with reference to exemplary embodiments thereof, these embodiments are only proposed for illustrative purposes and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A method of recognizing a parking floor for a vehicle, the method comprising:
recognizing a spot at which the vehicle enters a parking deck;
obtaining an inclination signal indicating an inclination trajectory of the vehicle traveling during a parking period from entry to the parking deck to parking;
obtaining an inclination pulse of the inclination signal based on a reference inclination value; and
determining a floor number of the parking deck on which the vehicle is parked using the inclination pulse.

2. The method according to claim 1, wherein polygon information about a building having the parking deck and about an entrance of the parking deck is compared with GPS information of the vehicle to recognize the building that the vehicle has entered and the entrance that the vehicle has entered.

3. The method according to claim 2, wherein inclination values of the vehicle calculated during the parking period are accumulated to generate the inclination signal.

4. The method according to claim 1, wherein obtaining the inclination pulse comprises:
setting the reference inclination value; and
determining a section of the inclination signal, not including the set reference inclination value, to be the inclination pulse.

5. The method according to claim 4, wherein an inclination value of 0 is set as the reference inclination value.

6. The method according to claim 4, wherein an inclination value most frequently intersecting the inclination signal is set as the reference inclination value.

7. The method according to claim 6, wherein the reference inclination value is greater than 0 by a predetermined value.

8. The method according to claim 4, wherein adjacent sections of the inclination signal are regarded as either one inclination pulse or separate inclination pulses.

9. The method according to claim 8, further comprising notifying a user of the determined floor number.

10. The method according to claim 9, further comprising, upon receiving a request for correction of the determined floor number, re-determining the floor number in a manner of regarding the adjacent sections as the other of the separate inclination pulses and the one inclination pulse.

11. The method according to claim 8, further comprising:
receiving a request for correction of the determined floor number; and
re-determining the floor number in a manner of regarding the adjacent sections as the other of the separate inclination pulses and the one inclination pulse.

12. A non-transitory computer-readable recording medium having therein a program to execute the method of claim 1.

13. A method of recognizing a parking floor for a vehicle, the method comprising:
recognizing a spot at which the vehicle enters a parking deck;
obtaining inclination signals each indicating an inclination trajectory of the vehicle traveling during a parking period from entry to the parking deck to parking;
obtaining inclination pulses of the inclination signals based on a reference inclination value; and
determining a floor number of the parking deck on which the vehicle is parked using the inclination pulses, wherein determining the floor number comprises:
assigning a +1 value to each inclination pulse corresponding to a section having an inclination value greater than the reference inclination value and assigning a −1 value to each inclination pulse corresponding to a section having an inclination value smaller than the reference inclination value;
summing all of the +1 and −1 values assigned to the inclination pulses; and
adding 1 to a result of the summing.

14. The method according to claim 13, wherein a result of the adding is determined to be a final floor number.

15. The method according to claim 13, wherein determining the floor number further comprises:
obtaining acceleration signals indicating a trajectory of accelerations of the vehicle during the parking period;
obtaining acceleration pulses of the acceleration signals;
determining the floor number using the acceleration pulses; and
determining a larger value among the floor number obtained using the inclination pulses and the floor number obtained using the acceleration pulses to be a final floor number.

16. The method according to claim 13, wherein determining the floor number further comprises:
obtaining acceleration signals indicating a trajectory of an acceleration of the vehicle during the parking period;
obtaining acceleration pulses of the acceleration signals;
determining the floor number using the acceleration pulses;
obtaining steering angle signals indicating a trajectory of a steering angle of the vehicle during the parking period;
obtaining steering angle pulses of the steering angle signals;
determining the floor number using the steering angle pulses; and
determining a median value among the floor numbers obtained using the inclination pulses, the acceleration pulses, and the steering angle pulses to be a final floor number.

17. A non-transitory computer-readable recording medium having therein a program to execute the method of claim 13, the recording medium storing a program to implement:
a function of recognizing the spot at which the vehicle enters the parking deck;
a function of obtaining the inclination signals indicating the inclination trajectory of the vehicle traveling during the parking period from entry to the parking deck to parking;
a function of obtaining the inclination pulses of the inclination signals based on the reference inclination value; and
a function of determining the floor number of the parking deck on which the vehicle is parked using the inclination pulses.

18. A vehicle comprising:
a vehicle body; and
a system mounted in the vehicle body, the system being configured to:
recognize a spot at which the vehicle enters a parking deck;
obtain an inclination signal indicating an inclination trajectory of the vehicle traveling during a parking period from entry to the parking deck to parking;
obtain an inclination pulse of the inclination signal based on a reference inclination value; and
determine a floor number of the parking deck on which the vehicle is parked using the inclination pulse.

19. The vehicle according to claim 18, wherein the system is configured to receive polygon information about a building having the parking deck and about an entrance of the parking deck and to compare the polygon information with GPS information of the vehicle to recognize the building that the vehicle has entered and the entrance that the vehicle has entered.

20. The vehicle according to claim 18, wherein, to obtain the inclination pulse, the system is configured to:
set a reference inclination value; and
determine a section of the inclination signal, not including the set reference inclination value, to be the inclination pulse.
